(19) United States
(12) Patent Application Publication
(10) Pub. No.: US 2023/0092982 A1
(43) Pub. Date: Mar. 23, 2023

(54) Torsional Vibration Damper with Axially Compressed Spring

(71) Applicant: Suhale Manzoor, Lebanon, TN (US)

(72) Inventor: Suhale Manzoor, Lebanon, TN (US)

(73) Assignee: Optimized Solutions, LLC, Lebanon, TN (US)

(21) Appl. No.: 17/947,067

(22) Filed: Sep. 16, 2022

Related U.S. Application Data
(60) Provisional application No. 63/261,300, filed on Sep. 17, 2021.

(51) Int. Cl. F16H 55/36

(52) U.S. Cl. CPC F16H 55/36; F16H 2055/366

(57) ABSTRACT

The invention discloses a novel method for constructing a torsional vibration damper where the spring damper system is aligned axially with the axis of the device, and it is put into compression by axially reducing its width and simultaneously preventing radial expansion. The assembly of the torsional vibration damper occurs in two progressive controlled stages by torquing a set of fasteners, thereby minimizing the shear strain on the elastomer during assembly, enhancing structural robustness, modally stability, and serviceability in the field.

### FIELD OF INVENTION

The present invention generally relates to Torsional Vibration Dampers (TVDs). More particularly the invention teaches a novel method of constructing a TVD where the elastomer axis is coincident with the axis of the TVD and the spring of the TVD is compressed along its axial width in two stages during assembly.

### BACKGROUND

Vibrating shafts have torsional vibrations inherent due to their non-uniform construction (e.g. crankshafts, and camshafts), or the nature of the driving mechanism employed (e.g. firing order of an internal combustion engine, or type of gearing), or the method employed for their connection to another shaft (e.g. through a universal, or a constant-velocity joint). These torsional vibrations if left unattended, reach a peak amplitude when their exciting frequency coincides with the natural torsional frequency of the shaft. This phenomenon known as resonance can cause premature fatigue failure of the shaft or can be felt as undesirable noise or vibration by a vehicle or machine operator.

Torsional Vibration Dampers (TVDs) are commonly employed to attenuate such undesirable vibrations. The objective of a TVD is to break the vibratory amplitude peak at resonance to two (or more) smaller peaks which have sufficiently reduced amplitudes that can be sustained by the shaft.

Most often, a TVD consists of a metallic bracket called the hub that rigidly attaches to the vibrating shaft. An active metallic inertial component called the ring that provides the inertial system, and an elastomeric member called the spring that connects the hub and the ring and provides the requisite spring-damper system. The TVD is tuned (by adjusting inertia, and spring-stiffness) such that the TVD attenuates the torsional vibrations of the shaft at resonance by vibrating at the same frequency but exactly out of phase with the vibrating shaft, thereby essentially cancelling the vibration.

Most commonly, two geometric configurations for the spring are utilized in TVDs: (1) where the spring is oriented parallel to the axial centerline of the TVD (axially oriented); and (2) where the spring is oriented orthogonal to the axial centerline of the TVD (radially oriented). Of these two configurations the axially oriented construction is generally favored over the radially oriented construction for the reason that it is more cost-effective to manufacture. For the remainder of the disclosure, only the axial construction will be discussed as the invention falls into this design category.

FIG. 1 illustrates a section view of an axially oriented TVD that is widely employed in the industry today. Such a TVD has three components: a hub 1a that is usually a cast-and-machined, stamped, or a spun metallic component, an inertial ring 2a that is usually a cast-and-machined metallic component that may have a poly-vee, v-groove, or any other feature, on its outermost radial periphery to receive a belt, chain or gear, and an polymer based ring or strip called the spring 3a that is press-fitted between the outer diametric surface 12a of hub 1a and the inner diametric surface 21a of ring 2a that holds hub 1a and ring 2a mutually in place and simultaneously provides the spring-damper system for the TVD.

The spring 3a in the uninstalled state has a radial wall thickness that exceeds the radial thickness of the gap between surface 12a and surface 21a; correspondingly the width of spring 3a in the uninstalled state is smaller than the axial width of the radial gap such that the volume of spring 3a is equal to the volume of the radial gap between hub 1a and ring 2a. This is done to ensure that after assembly spring 3a in its state of radial compression and axial expansion, occupies the entire radial gap between hub 1a and ring 2a. There are three limitations to conventional TVDs as illustrated in FIG. 1.

The first limitation is that spring 3a is forced into place between surface 12a and ring 21a by employing an electric or hydraulic press and an assembly fixture. Such an assembly causes significant damage to the spring 3a due to the shear strains induced at the metallic interfaces. In fact, the strain induced in spring 3a during such assembly far exceeds what spring 3a experiences during the application; and consequently, the durability of spring 3a is essentially compromised before experiencing any duty cycles.

A second limitation is the inability of such a device to be serviced in the field following a failure of spring 3a as the dis-assembly and assembly of a conventional TVD requires special fixturing and presses. The only recourse is to scrap the TVD and replace it with a new TVD. This leads to significant loss of time and incurs unnecessary scrapping of the undamaged metallic components namely hub 1a and ring 2a and the replacement costs thereof.

A third limitation is that increasing the radial thickness of the gap between surface 12a and surface 21a causes a lowering of the frequency of the TVD and introduces modal instability where the torsional mode either no longer remains the first mode of vibration or is not adequately decoupled from the other modes of vibration such as the axial, conical, and radial modes. However, a known advantage of increasing the thickness of the radial gap between surface 12a and surface 21a is that it allows the spring to have a larger volume and thereby enhance the ability of the TVD to dissipate power along with its capability to undertake a larger dynamic shear stress. Therefore, in the conventional design as illustrated in FIG. 1 there is a geometric threshold that must balanced to ensure both Noise Vibration and Harshness (NVH) performance (avoiding modal instability) and structural robustness (maximizing power dissipation and undertaking shear stress) of the TVD are achieved.

FIG. 2 illustrates an alternate construction that has been contemplated before called the Recessed Belt Damper (RBD), which is essentially a similar construction as FIG. 1 with side walls 11b and 11b′ of the hub 1b extend radially to axially restrict the expansion of spring 3b. Such a construction avoids the necessity for an elaborate assembly fixture. Here spring 3b (usually a ring) is first stretched and mounted on the outer diametric surface 12b of hub 1b and then the resulting sub-assembly is forced onto the inner diametric surface 21b of ring 2b. There are two added advantages of this construction over that illustrated in FIG. 1: (1) the spring 3b undergoes a much smaller radial compression to yield the necessary retention force to hold hub 1b and ring 2b with respect to each other; (2) such a construction promotes modal stability.

However, the RBD construction has not gained popularity in the industry due to three inherent flaws in the design: (1) the process of stretching and mounting of spring 3b (usually a ring) onto surface 12b is not easy to accomplish without complex automated fixturing; (2) the assembly process puts enormous shear strain on spring 3b particularly proximate to surface 21b, thereby prematurely rupturing spring 3b; and (3) the enormous hydrostatic pressure exerted by spring 3b onto on the side walls 11b and 12b often leads to cracking of one or both of these side walls; therefore rendering the RBD ineffective.

Additionally, the RBD is not serviceable in the field and like the traditional TVD illustrated in FIG. 1, requires a swap of the complete device, and the consequential unnecessary expense incurred to replace the metallic components thereof.

Therefore, an axially oriented TVD that minimizes assembly strains on the spring, is structurally robust, modally stable, and serviceable in the field is needed.

### SUMMARY OF INVENTION

The disclosed invention describes a novel method for constructing an axially oriented TVD that minimizes assembly strains on the elastomer, is structurally robust, modally stable, and serviceable in the field.

The essence of the invention is to create a device that can be assembled in two separate stages, thereby inducing minimal shear strain on the elastomer during assembly. During stage 1 the spring is assembled onto the hub without stretching the same, and during stage 2 the resulting sub-assembly is mounted into the ring radially as opposed to axially as in the prior art. Both the stages are accomplished by progressively bringing the two pieces of the hub closer by a clamping mechanism.

The hub is a two-piece compound rigid structure that is clamped using standard bolts and nuts. Materials for the hub include but are not limited to (1) Steels; (2) Irons; (3) Aluminums; (4) Synthetic Polymers including but not limited to Glass-Filled Nylon, Non-Glass Filled Nylon, Polyethylene, Polycarbonates, Polyvinyl etc.

The ring is a monolithic rigid structure that may or may not have a poly vee groove or other feature to receive a serpentine belt, chain, or gear. Materials for the ring include but are not limited to (1) Steels; (2) Irons; (3) Aluminums; (4) Synthetic Polymers including but not limited to Glass-Filled Nylon, Non-Glass Filled Nylon, Polyethylene, Polycarbonates, Polyvinyl etc.

The spring used is novel and differs from prior art as its axial width (and not its radial thickness) is compressed during assembly. Meaning that the unassembled spring is longer in axial width and thinner in radial thickness when compared to its fully assembled state. This spring may comprise of any material so-long-as it enables the spring to have a finite stiffness and a finite damping-coefficient. Such materials include but are not limited to (1) Thermo-Set Elastomers including but not limited to Natural Rubber (NR), Styrene-Butadiene Rubber (SBR), Acrylonitrile Butadiene Rubber (NBR), Ethelene Propylene Diene Monomer (EPDM), Poly-Butadiene (PBD) etc.; (2) Thermo-Plastic Elastomers (TPEs); (3) Synthetic Polymers including but not limited to Glass-Filled Nylon, Non-Glass Filled Nylon, Polyethylene, Polycarbonates, Polyvinyl etc.

This invention and the method of assembly thereof may be further appreciated considering the following detailed description and drawings in which:

### BRIEF DESCRIPTION OF THE DRAWINGS

FIG. 1 is a cross-sectional view illustrating the structure of a conventional TVD.

FIG. 2 is a cross-sectional view illustrating the structure of an RBD with axial sidewalls supporting the elastomer.

FIG. 3 is a cross-sectional view illustrating the internal structure of an embodiment of the invention where the compound hub is radially inward of the monolithic ring after the stage 1 of assembly.

FIG. 4 is a cross-sectional view illustrating the internal structure of the embodiment of the invention illustrated in FIG. 3 after the stage 2 of assembly.

FIG. 5 is a cross-sectional view illustrating an embodiment of the invention where the compound ring is radially outward of the monolithic hub.

FIG. 6 is a cross-sectional view illustrating an embodiment of the invention where the spring has a compound structure comprising of several axis-symmetric segments.

FIG. 7 is a cross-sectional view illustrating an embodiment of the invention where the compound ring is radially inward of the monolithic hub.

FIG. 8 is a cross-sectional view illustrating an embodiment of the invention where the compound hub is radially outward of the monolithic ring.

FIG. 9 is a partial cross-sectional view illustrating four different possible geometric configurations of the gap between the hub and the ring that enable the components to mutually align during assembly.

FIG. 10 is a partial cross-sectional view illustrating two different methods to incorporate a female fastener thread into the design that can receive the male thread of the plurality of bolts that clamp the hub.

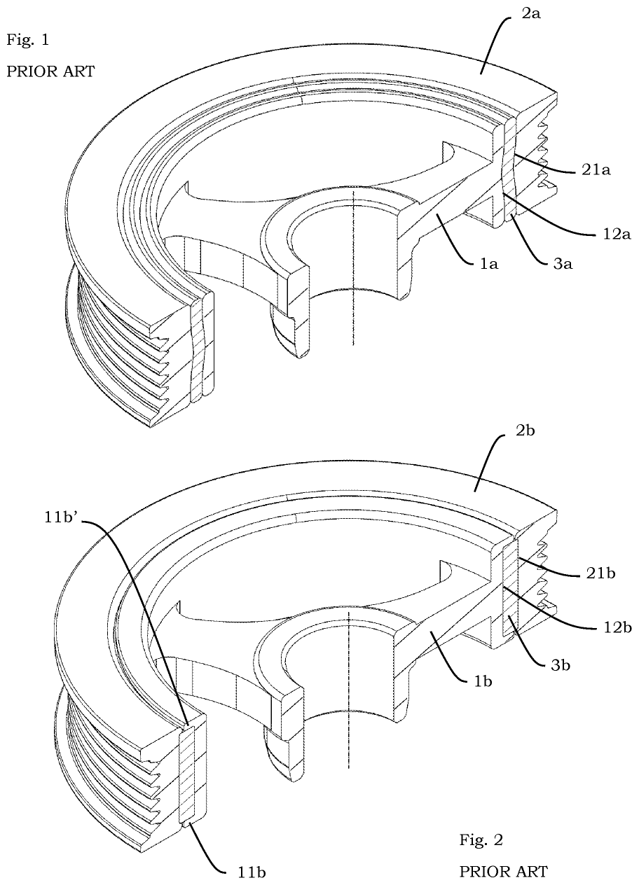

### DETAILED DESCRIPTION

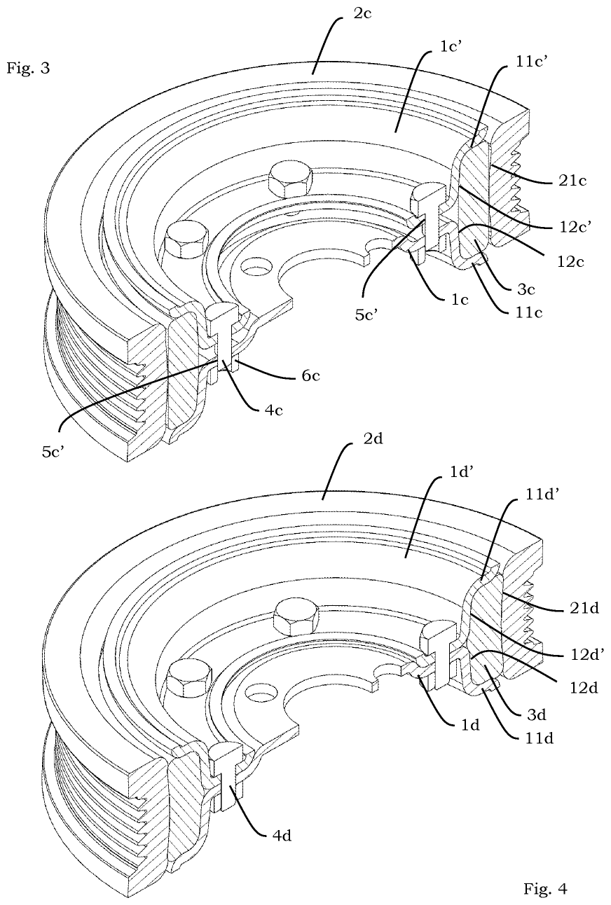

FIG. 3 illustrates an embodiment of the invention after stage 1 of the assembly has been completed. The compound hub comprises of two parts 1c and 1c′. Both parts 1c and 1c′ each have a plurality of through holes 5c and 5c′ respectively for the pass through of a plurality of bolts 4c; meanwhile, part 1c has a plurality of welded nuts 6c each centered around the plurality of through holes 5c to receive the plurality of bolts 4c. The ring 2c and the spring 3c are monolithic in structure.

In stage 1 of the assembly process, part 1c is placed on a horizontal surface followed by slipping the spring 3c over the half channel defined by surface 11c and surface 12c that support spring 3c axially and radially respectively. Spring 3c is designed such that it diametrically slips over the partial channel defined by surface 12c and rests on surface 11c in the unassembled position. Part 1c′ is then slipped under spring 3c such that it axially opposes part 1c and surface 11c′ and surface 12c′ support spring 3c axially and radially respectively. The plurality of bolts 4c are chosen such that their length is sufficient to pass through the plurality of through holes 5c and 5c′ and engage with the threads of the plurality of welded nuts 6c. The plurality of bolts 4c are partially torqued to a pre-determined value such that outermost diametric surface of spring 3c can slip under the entirety of surface 21c of ring 2c. The ring 2c is then slipped over spring 3c such that it aligns axially with the compound hub subassembly. This concludes stage 1 of the assembly process.

FIG. 4. illustrates the same embodiment of the invention as illustrated in FIG. 3 but after stage 2 of the assembly process, the plurality of bolts 4d are fully torqued to a predetermined value such that parts 1d and 1d′ come into mutual contact with each other and a compound channel is formed by surfaces 11d, 11d′, 12d, and 12d′. Spring 3d is compressed axially by surfaces 11d and 11d′ and is simultaneously not allowed to expand radially inward by surfaces 12d and 12d′ respectively. Spring 3d is thereby forced to expand radially outward and clamp on surface 21d of ring 2d. The ring surface 21d and the compound surface defined by 12d and 12d′ are designed with a geometric configuration that allows ring 2d to self-center axially and radially with respect to the compound hub formed by parts 1d, 1d′ after stage 2 of the assembly.

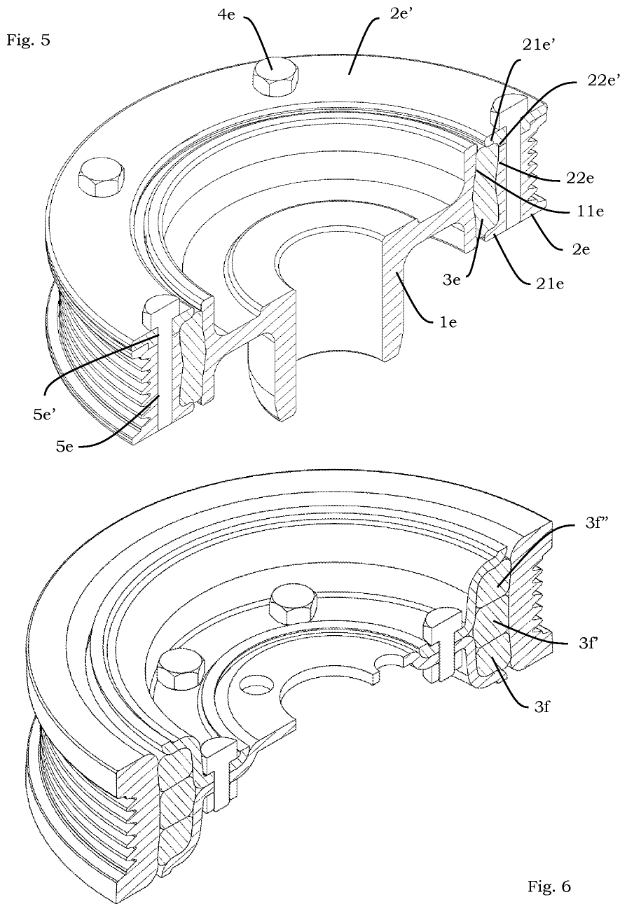

FIG. 5 illustrates an embodiment of the invention after completion of both stage 1 and stage 2 of the assembly process where the compound ring comprises of two parts 2e and 2e′. part 2e′ has a plurality of through holes for the pass through of a plurality of bolts 4e; meanwhile, part 1c has a plurality of threaded holds 5e to receive the plurality of bolts 4e. The hub 1e and the spring 3c are monolithic in structure.

In stage 1 of the assembly process, part 2e is placed on a horizontal surface followed by slipping the spring 3e under the partial channel defined by surface 21e and surface 22e that support spring 3e axially and radially respectively. Spring 3e is designed such that it diametrically slips over the partial channel defined by surface 21e and rests on surface 21e in the unassembled position. Part 2e′ is then slipped over spring 3e such that it axially opposes part 2e and side wall 21e′ and bottom wall 22e′ support spring 3e axially and radially respectively. The plurality of bolts 4e are chosen such that their length is sufficient to pass through the plurality of through holes 5e′ and engage with the threads in the plurality of holes 5e. The plurality of bolts 4e are partially torqued to a pre-determined value such that innermost diametric surface of spring 3e slips over the entirety of surface 11e of hub 1e. The hub 1e is then slipped under spring 3e such that it aligns axially with the compound ring subassembly. This concludes the stage 1 of the assembly process.

In stage 2 of the assembly process, the plurality of bolts 4e are fully torqued to a predetermined value such that parts 1d and 1d′ come into mutual contact with each other and a compound channel is formed by surface 21e and 21e′ and surface 22e and 22e′. The spring 3e is compressed axially by surfaces 21e and 21e′ and is simultaneously not allowed to expand radially outward by surfaces 22e and 22e′ respectively. Spring 3e is thereby forced to expand radially inward and clamp on surface 11e of hub 1e. The hub surface 11e and compound surface defined by 22e and 22e′ are designed with a geometric configuration that allows hub 1d to self-center axially and radially with respect to the compound ring formed by parts 2e, 2e′ after stage 2 of the assembly.

FIG. 6 illustrates an embodiment of the invention that is identical to the embodiment illustrated in FIG. 4 with the exception that the spring is not monolithic but consists of a plurality of tubular segments 3f, 3f′, and 3f″. These tubular sections may include but are not limited to O-rings, square rings, X Rings etc.

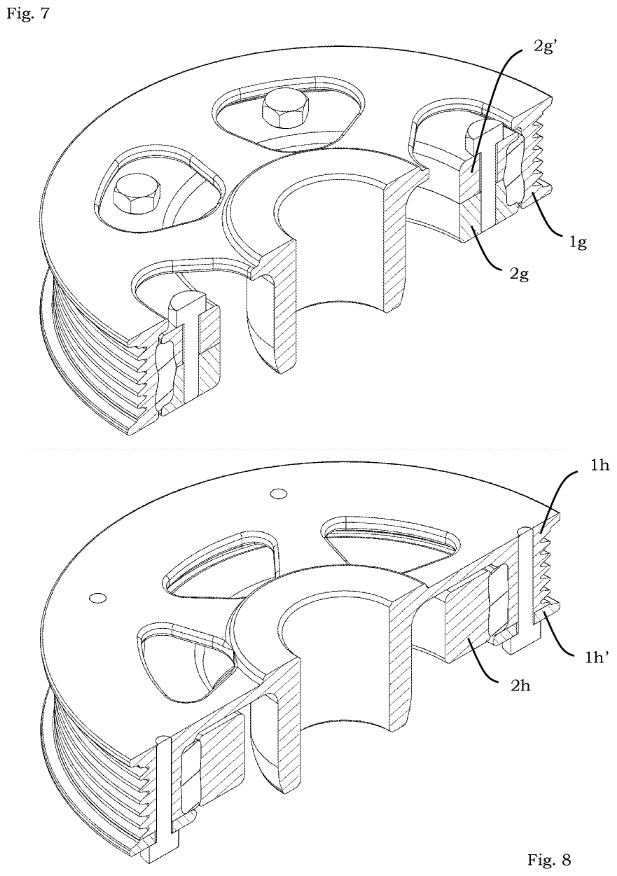

FIG. 7 illustrates an embodiment of the invention that is identical to the embodiment illustrated in FIG. 5 with the exception that the compound ring comprising of two parts 2g and 2g′, is positioned radially inward of the monolithic hub 1g.

FIG. 8 illustrates an embodiment of the invention that is identical to the embodiment illustrated in FIG. 4 with the exception that the compound hub comprising of two parts 1h and 1h′, is positioned radially outward of the monolithic ring 2h.

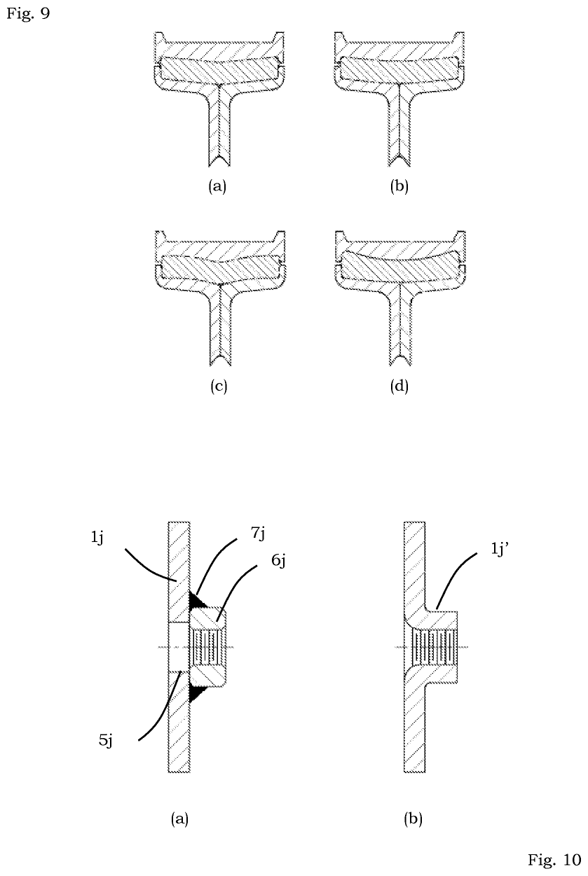

FIG. 9 illustrates four alternate geometric configurations of the gap between the hub and the ring of the TVD that is occupied by the spring after assembly: (a) where the radial walls are parallel, inclined straight lines; (b) where the radial walls are parallel arcs; (c) where the radial walls are parallel complex curves; and (d) where the radial walls are non-parallel complex curves. It must be appreciated that these are just a few examples that allow for the radial and axial alignment between the hub and the ring during and after full assembly. There are an infinite number such combinations possible.

FIG. 10 illustrates two alternate embodiments for receiving the bolts in the embodiments illustrated in FIG. 4, FIG. 6, and FIG. 8. (a) Illustrates nut 6j attached to hub 1j centered around through holes 5j via weld 7j. (b) Illustrates a monolithic hub 1j′ which is threaded.

The advantages yielded by the invention over the illustrated prior art stems from the novel method of compressing the spring by reducing its axial width as opposed to its radial thickness. This allows the construction of an axially oriented TVD that: (1) minimizes shear strain on the spring during assembly, thereby putting the spring into compression without damaging it structurally; (2) increases the volume of the spring thereby enhancing its structural robustness to undertake greater shear stress and improve power dissipation; (3) force the first mode-shape of the TVD to be torsional in nature and adequately decouples the modal frequencies therefore enhancing NVH response; and (4) Allows the damper to be serviced in the filed if/when the spring fails by merely loosening the bolts, separating the metallic components, replacing the damaged spring with a new spring, and reassembling the TVD without disengaging the hub from the rotating shaft, and consequently reducing machine downtime and eliminating unnecessary expense of replacing the hub and the ring.

The invention claimed is:

1. A torsional vibration damper comprising:
a compound hub further comprising:
a first part further comprising:
a first axis-symmetric surface bounding its radially distal periphery;
a second axis-symmetric surface adjacent to the first axis-symmetric surface extending radially outward and bounding its axial periphery; and
a plurality of axially oriented through holes;
a second part further comprising:
a third axis-symmetric surface bounding its radially distal periphery;
a fourth axis-symmetric surface adjacent to the third axis-symmetric surface extending radially outward and bounding its axial periphery and opposing the second axis-symmetric surface; and
a plurality of axially oriented threaded holes aligned with, and axially opposed to, the plurality of axially oriented holes in the first part of the hub;
a monolithic ring positioned radially outward to the hub further comprising:
a first axis-symmetric surface bounding its radially proximate periphery that is parallel to the compound surface created by the first and the third surfaces of the first and second part of the hub respectively after assembly;
a monolithic spring positioned centrally between the hub and the ring further comprising:
a first axis-symmetric surface bounding its radially proximate periphery;
a second axis-symmetric surface bounding its radially distal periphery;
a third axis-symmetric surface bounding its axial periphery and adjacent to the first and second surfaces; and
a fourth axis-symmetric surface bounding its axial periphery adjacent to the first and second surfaces, and opposing the third surface;
a plurality of bolts that pass through the plurality of holes in the first part of the hub and engage with the plurality of threaded holes in the second part of the hub;
wherein partial torquing of the plurality of the bolts causes the first and second parts of the hub to come axially closer to each other thereby partially compressing the centrally positioned spring when the second and fourth surfaces of the first and second part of the hub push against the third and fourth surfaces of the spring respectively, and the first and third surfaces of the of the first and second part hub radially restrict the inward expansion of the spring forcing it to expand radially outward such that the deformed second surface of the spring forms a slip fit with the first surface of the ring; and the complete torquing of the plurality of bolts causes the first and second parts of the hub to come into mutual contact and axially compress the centrally positioned spring when the second and fourth surfaces of the first and second part of the hub push against the third and fourth surfaces of the spring respectively, and the first and third surfaces of the hub and the first surface of the ring restrict the radial expansion of the first and second axis-symmetric surfaces of the spring thereby causing it to compress and occupy the compound partially enclosed channel defined by the first, second, third, and fourth surfaces of the first and second part of the hub respectively and the first surface of the ring.

2. The torsional vibration damper of claim 1 where the spring is replaced by a compound spring comprising of two or more separate sections.

3. The torsional vibration damper of claim 1 where the first surface of the ring is not parallel to the compound surface created by the first and the third surfaces of the first and second part of the hub respectively after assembly.

4. The torsional vibration damper of claim 1 where the second part of the hub has a plurality of holes centered around each a plurality of nuts is rigidly attached for receiving the bolts that pass through the plurality of holes in the first and second parts of the hub respectively.

5. The torsional vibration damper of claim 1 where the ring is positioned radially proximate to the hub.

6. A torsional vibration damper comprising:
a compound ring further comprising:
a first part further comprising:
a first axis-symmetric surface bounding its radially proximate periphery;
a second axis-symmetric surface adjacent to the first axis-symmetric surface extending radially inward bounding its axial periphery; and
a plurality of axially oriented through holes;
a second part further comprising:
a third axis-symmetric surface bounding its radially proximate periphery;
a fourth axis-symmetric surface adjacent to the third axis-symmetric surface extending radially inward bounding its axial periphery and opposing the second axis-symmetric surface; and
a plurality of axially oriented threaded holes aligned with, and axially opposed to, the plurality of axially oriented holes in the first part of the ring;
a monolithic hub positioned radially inward to the ring further comprising:
a first axis-symmetric surface bounding its radially distal periphery that is parallel to the compound surface created by the first and the third surfaces of the first and second part of the ring respectively after assembly;
a monolithic spring positioned centrally between the hub and the ring further comprising:
a first axis-symmetric surface bounding its radially proximate periphery;
a second axis-symmetric surface bounding its radially distal periphery;
a third axis-symmetric surface bounding its axial periphery and adjacent to the first and second surfaces; and
a fourth axis-symmetric surface bounding its axial periphery adjacent to the first and second surfaces, and opposing the third surface;
a plurality of bolts that pass through the plurality of holes in the first part of the ring and engage with the plurality of threaded holes in the second part of the ring;
wherein partial torquing of the plurality of the bolts causes the first and second parts of the ring to come axially closer to each other thereby partially compressing the centrally positioned spring when the second and fourth surfaces of the first and second part of the ring push against the third and fourth surfaces of the spring respectively, and the first and third surfaces of the first and second part of the ring radially restrict the outward expansion of the spring forcing it to expand radially inward such that the deformed first surface of the spring forms a slip fit with the first surface of the hub; and the complete torquing of the plurality of bolts causes the first and second parts of the ring to come into mutual contact and axially compress the centrally positioned spring when the second and fourth surfaces of the first and second part of the ring push against the third and fourth surfaces of the spring respectively, and the first and third surfaces of the ring and the first surface of the hub restrict the radial expansion of the first and second axis-symmetric surfaces of the spring thereby causing it to compress and occupy the compound partially enclosed channel defined by the first, second, third, and fourth surfaces of the first and second part of the ring respectively and the first surface of the hub.

7. The torsional vibration damper of claim 6 where the spring is replaced by a compound spring comprising of two or more separate sections.

8. The torsional vibration damper of claim 6 where the first surface of the hub is not parallel to the compound surface created by the first and the third surfaces of the first and second part of the respectively after assembly.

9. The torsional vibration damper of claim 6 where the ring is positioned radially proximate to the hub.
